(19) United States
(12) Patent Application Publication
(10) Pub. No.: US 2026/0271164 A1
(43) Pub. Date: Sep. 10, 2026

(54) APPARATUS FOR CONTROLLING LAMP, SMART LAMP AND METHOD FOR CONTROLLING LAMP

(71) Applicants: SAVANT TECHNOLOGIES LLC, East Cleveland, OH (US); Shanghai Bright Power Semiconductor Co., Ltd., Shanghai (CN)

(72) Inventors: Yimin ZHU, Shanghai (CN); Zhiyong WANG, Shanghai (CN); Zhichao LIU, Shanghai (CN); Xuan FU, Shanghai (CN); Hai ZHU, Shanghai (CN); Pengbo YANG, Shanghai (CN)

(73) Assignees: SAVANT TECHNOLOGIES LLC, East Cleveland, OH (US); Shanghai Bright Power Semiconductor Co., Ltd., Shanghai (CN)

(21) Appl. No.: 19/544,559

(22) Filed: Feb. 19, 2026

(30) Foreign Application Priority Data
Feb. 20, 2025 (CN) 202510191725.1

(51) Int. Cl. H05B 47/19; H05B 45/14

(52) U.S. Cl. CPC H05B 47/19; H05B 45/14

(57) ABSTRACT

Provided is an apparatus for controlling a lamp, a smart lamp and a method for controlling a lamp that includes a bleeder module that generates a current signal based on an operating state of the lamp and transmits the current signal to a phase cut dimmer that receives an external alternating-current signal, and controls the on/off of the external alternating-current signal by changing a phase cut angle, a phase cut angle measurement module that measures the phase cut angle, a logic module that receives the phase cut angle and generates a phase cut angle signal, a control module that receives the phase cut angle signal generates a dimming signal and transmits the dimming signal to the logic module that generates a control signal based on the dimming signal, and a dimming module that receives the control signal and perform dimming control on the lamp based on the control signal.

### CROSS-REFERENCE TO RELATED APPLICATIONS

This application claims priority to Chinese Patent Application Serial Number 202510191725.1, filed Feb. 20, 2025, which is herein incorporated by reference.

### TECHNICAL FIELD

The present invention relates to the technical field of lighting control, and in particular, to an apparatus for dimming control of a smart lamp, a smart lamp, and a method for controlling a lamp.

### BACKGROUND

A phase cut dimmer, also known as a phase control dimmer, is an electronic device that is widely used to adjust the brightness of a lighting device powered by an alternating-current power supply. The main function thereof is to control the brightness of a lamp by changing the conduction angle (i.e. phase angle) of a sinusoidal waveform. The phase cut dimmer is widely applied in domestic, commercial and industrial lighting systems, especially in occasions where the brightness of lamplight needs to be adjusted according to environmental or activity changes. However, with the widespread use of smart lamps, challenges are posed to compatibility issues between smart lamps and phase cut dimmers. Especially, under a small-angle phase cut condition, normal operation of a lamp may be interfered by the following factors: 1) voltage spike: when a phase cut dimmer performs small-angle phase cut, a voltage spike will be generated at the moment when a power supply is conducted, and as the voltage of the power supply rapidly rises from zero at this moment, over-voltage damage may be caused to a driver IC of an LED lamp; 2) current instability: the conduction time of the power supply becomes short, which causes the current supplied to an LED to be unstable, and may cause light flickering or anomalous dimming; and 3) change of working condition of the driver IC: under small-angle phase cut, the driver IC may work in the case of insufficient conduction time of the power supply, and cannot start normally or maintain stable output.

### SUMMARY OF THE INVENTION

Embodiments of the present application provide an apparatus for dimming control of a smart lamp, a smart lamp and a method for controlling a lamp, so as to at least solve the technical problem in the prior art that it is difficult to make a smart lamp and a phase cut dimmer compatible with each other.

According to embodiments of the present application, provided is an apparatus having a lamp controlled by a wireless controller, said apparatus comprising: a bleeder module, configured to generate a current signal on the basis of an operating state of the lamp and transmit the current signal to a phase cut dimmer; wherein the phase cut dimmer receives an external alternating-current signal, and controls the on or off of the external alternating-current signal by changing a phase cut angle; a phase cut angle measurement module, configured to measure the phase cut angle of the phase cut dimmer; a logic module, configured to receive the phase cut angle measured by the phase cut angle measurement module and generate a phase cut angle signal on the basis of the phase cut angle; a control module, configured to receive the phase cut angle signal of the logic module, generate a dimming signal on the basis of the phase cut angle signal, and transmit the dimming signal to the logic module, the logic module generating a control signal on the basis of the dimming signal; and a lamp control module, configured to receive the control signal of the logic module and perform dimming control on the lamp on the basis of the control signal.

In this way, the compatibility between the smart lamp and the phase cut dimmer can be ensured.

Preferably, the control module comprises: a limit unit, configured to generate a limit signal on the basis of the phase cut angle signal, the limit signal defining the maximum current of the lamp; an adjustment unit, configured to generate an adjustment signal, the adjustment signal defining an adjustment range of the dimming signal; and a dimming signal generation unit, configured to generate the dimming signal on the basis of the limit signal and the adjustment signal.

In this way, the upper limit of the maximum allowable output of the lamp can be set according to the measurement result.

Preferably, the control module further comprises: a communication unit, configured to receive an external control signal, and generate the adjustment signal on the basis of the external control signal.

In this way, the smart lamp is used without changing an existing phase cut dimmer, thereby improving the user friendliness and market acceptance of the smart lamp.

Preferably, the communication unit receives the external control signal sent by a user in a wired or wireless manner.

In this way, the percentage of the maximum allowable output can be adjusted, providing a flexible control scheme for the user.

Preferably, the logic module detects the operating state of the lamp, and controls a working state of the bleeder module on the basis of the operating state of the lamp.

Preferably, the logic module detects the operating state of the lamp; and when the operating state of the lamp indicates that a working current of the lamp is greater than a predetermined threshold, the working state of the bleeder module is controlled to be switched to a standby state, wherein in the standby state, the bleeder module does not transmit the current signal to the phase cut dimmer; and when the operating state of the lamp indicates that the working current of the lamp is smaller than the predetermined threshold, the working state of the bleeder module is controlled to be switched to a normal operating state, wherein in the normal operating state, the bleeder module transmits the current signal to the phase cut dimmer.

In this way, the power consumption of the apparatus can be reduced while the compatibility between the smart lamp and the phase cut dimmer is ensured.

Preferably, the logic module comprises: a limit unit, configured to generate a limit signal on the basis of the phase cut angle signal, the limit signal defining the maximum current of the lamp.

Preferably, the control module comprises: an adjustment unit, configured to generate an adjustment signal, the adjustment signal defining an adjustment range of the dimming signal; and a dimming signal generation unit, configured to generate the dimming signal on the basis of the adjustment signal.

Preferably, the logic module generates the control signal on the basis of the dimming signal and the limit signal.

According to embodiments of the present application, provided is a smart lamp controlled by a wireless controller, the smart lamp comprising: a light source, the light source being capable of generating light having two or more brightness; and an apparatus for controlling the light source, the apparatus comprising: a bleeder module, configured to generate a current signal on the basis of an operating state of the lamp and transmit the current signal to a phase cut dimmer; wherein the phase cut dimmer receives an external alternating-current signal, and controls the on or off of the external alternating-current signal by changing a phase cut angle; a phase cut angle measurement module, configured to measure the phase cut angle of the phase cut dimmer; a logic module, configured to receive the phase cut angle measured by the phase cut angle measurement module and generate a phase cut angle signal representing the phase cut angle; a control module, configured to receive the phase cut angle signal of the logic module, generate a dimming signal on the basis of the phase cut angle signal, and transmit the dimming signal to the logic module, the logic module generating a control signal on the basis of the dimming signal; and a lamp control module, configured to receive the control signal of the logic module and perform dimming control on the lamp on the basis of the control signal.

Preferably, the control module comprises: a limit unit, configured to generate a limit signal on the basis of the phase cut angle signal, the limit signal defining the maximum current of the lamp; an adjustment unit, configured to generate an adjustment signal, the adjustment signal defining an adjustment range of the dimming signal; and a dimming signal generation unit, configured to generate the dimming signal on the basis of the limit signal and the adjustment signal.

Preferably, the control module further comprises: a communication unit, configured to receive an external control signal, and generate the adjustment signal on the basis of the external control signal.

Preferably, the communication unit receives the external control signal sent by a user in a wired or wireless manner.

Preferably, the logic module detects the operating state of the lamp, and controls a working state of the bleeder module on the basis of the operating state of the lamp.

Preferably, the logic module detects the operating state of the lamp; and when the operating state of the lamp indicates that a working current of the lamp is greater than a predetermined threshold, the working state of the bleeder module is controlled to be switched to a standby state, wherein in the standby state, the bleeder module does not transmit the current signal to the phase cut dimmer; and when the operating state of the lamp indicates that the working current of the lamp is smaller than the predetermined threshold, the working state of the bleeder module is controlled to be switched to a normal operating state, wherein in the normal operating state, the bleeder module transmits the current signal to the phase cut dimmer.

Preferably, the logic module comprises: a limit unit, configured to generate a limit signal on the basis of the phase cut angle signal, the limit signal defining the maximum current of the lamp.

Preferably, the logic module generates the control signal on the basis of the dimming signal and the limit signal.

According to embodiments of the present application, provided is a method for controlling a lamp, comprising: a bleeding step of generating a current signal on the basis of an operating state of the lamp and transmitting the current signal to a phase cut dimmer; wherein the phase cut dimmer receives an external alternating-current signal, and controls the on or off of the external alternating-current signal by changing a phase cut angle; a phase cut angle measuring step of measuring the phase cut angle of the phase cut dimmer; a phase cut angle signal generating step of receiving the phase cut angle measured in the phase cut angle measurement step and generating a phase cut angle signal representing the phase cut angle; a dimming signal generating step of receiving the phase cut angle signal generated in the phase cut angle signal generating step and generating a dimming signal on the basis of the phase cut angle signal; a control signal generating step of receiving the dimming signal generated in the dimming signal generating step and generating a control signal on the basis of the dimming signal; and a lamp controlling step of receiving the control signal generated in the control signal generating step and performing dimming control on the lamp on the basis of the control signal.

Preferably, the dimming signal generating step comprises the following sub-steps: a first sub-step of generating a limit signal on the basis of the phase cut angle signal, the limit signal defining the maximum current of the lamp; a second sub-step of generating an adjustment signal, the adjustment signal defining an adjustment range of the dimming signal; and a third sub-step of generating the dimming signal on the basis of the limit signal and the adjustment signal.

In the embodiments of the present application, the following technical means are adopted:
1) A bleeder circuit is introduced to ensure the compatibility between the smart lamp and the phase cut dimmer.
2) The phase cut angle measurement circuit is designed, such that a driver can set an upper limit of the maximum allowable output of the lamp according to the measurement result.
3) A smart controller can adjust the percentage of the maximum allowable output, providing a flexible control scheme for the user.
4) A phase detector module can sense a phase cut signal and transfer the signal to the logic module, so as to adjust a current output of the lamp according to the phase cut angle and the signal.

The following technical problems are solved: a smart lamp cannot perform dimming after a phase cut dimmer, that is, the smart lamp generally can only work under a large phase cut angle, but cannot perform normal dimming under the control of a small-angle or phase cut dimmer, limiting the usage scenario of the smart lamp and limiting the user experience. In this way, users can use the smart lamp without changing an existing phase cut dimmer, thereby improving the user friendliness and market acceptance of the smart lamp. In addition, the smart lamp supports two dimming modes, i.e. wireless control and phase cut dimming, thereby enhancing the control flexibility of the smart lamp and the universality of application scenarios.

### BRIEF DESCRIPTION OF THE DRAWINGS

Drawings illustrated herein are used for providing further understanding of the present application and constitute a part of the present application, and the illustrative embodiments of the present application and illustrations thereof are used for explaining the present application, rather than constitute inappropriate limitation on the present application. In the drawings:

FIG. 1 is a schematic diagram of an apparatus having a lamp controlled by a wireless controller according to an embodiment of the present application;

FIG. 2 is a schematic diagram of a control module according to an embodiment of the present application;

FIG. 3 is a schematic diagram of a logic module according to another embodiment of the present application;

FIG. 4 is a schematic diagram of a control module according to another embodiment of the present application;

FIG. 5 is a schematic diagram of an apparatus having a lamp controlled by a wireless controller according to another embodiment of the present application;

FIG. 6 is a schematic circuit diagram of an apparatus having a lamp controlled by a wireless controller according to another embodiment of the present application;

FIG. 7 is a flowchart of a method for controlling a lamp according to an embodiment of the present application; and

FIG. 8 is a schematic diagram of a smart lamp controlled by a wireless controller according to an embodiment of the present application.

### DETAILED DESCRIPTION

In order to enable a person skilled in the art to understand the solutions of the present application better, hereinafter, the technical solutions in the embodiments of the present application will be described clearly and thoroughly with reference to the accompanying drawings of embodiments of the present application. Obviously, the embodiments as described are only some of embodiments of the present application, and are not all the embodiments. All other embodiments obtained by a person of ordinary skill in the art on the basis of the embodiments in the present application without involving any inventive effort shall all fall within the scope of protection of the present application.

It should be noted that the terms "first", "second" etc., in the description, claims, and accompanying drawings of the present application are used to distinguish similar objects, and are not necessarily used to describe a specific sequence or order. It should be understood that the data so used may be interchanged where appropriate so that the embodiments of the present application described herein can be implemented in sequences other than those illustrated or described herein. In addition, terms "comprise" and "have" and any variations thereof are intended to cover a non-exclusive inclusion, for example, a process, method, system, product or device which comprises a series of steps or modules or units is not necessarily limited to those steps or modules or units that are clearly listed, but may comprise other steps or modules or units that are not clearly listed or inherent to these process, method, product, or device.

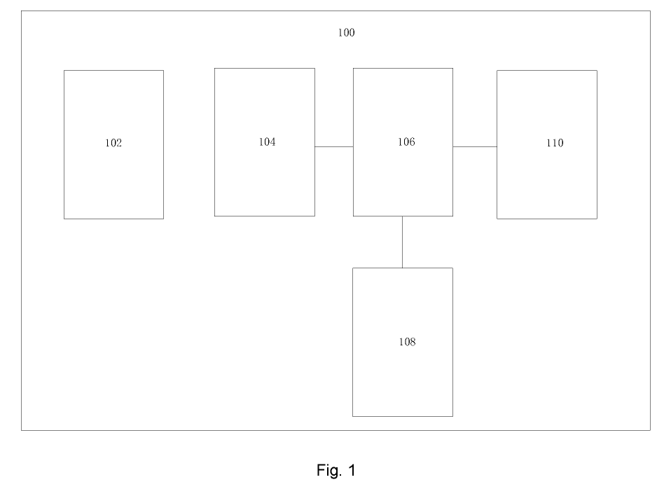

According to embodiments of the present application, an apparatus for controlling a lamp is provided. FIG. 1 is a schematic diagram of an apparatus for controlling a lamp according to an embodiment of the present application. As shown in FIG. 1, the apparatus 100 for controlling a lamp comprises: a bleeder module 102, a phase cut angle measurement module 104, a logic module 106, a control module 108 and a dimming module 110.

The bleeder module 102 is configured to generate a current signal on the basis of an operating state of the lamp and transmit the current signal to a phase cut dimmer (not shown). Although not specifically shown, as understood by a person skilled in the art, the phase cut dimmer, also known as a phase control dimmer, is an electronic device that is widely used to adjust the brightness of a lighting device powered by an alternating-current power supply. The main function of the phase cut dimmer is to control the brightness of the lamp by changing the conduction angle (i.e. phase angle) of a sinusoidal waveform. The specific operation is as follows: in each alternating-current cycle, the phase cut dimmer delays a conduction time point of the sinusoidal waveform, so that a part of a front half part or a rear half part of the waveform is cut off, thereby reducing effective values of a voltage and a current which are actually supplied to a bulb, and further realizing brightness adjustment. By the phase control, the phase cut dimmer can effectively reduce the power consumption of the bulb, thereby achieving the effect of energy saving. The phase cut dimmer can provide smooth brightness adjustment within a certain range from full brightness to turning-off, which can improve the comfort of a lighting environment and the effect of an atmosphere in many occasions. In addition, the phase cut dimmer is typically compatible with traditional incandescent lamps, halogen lamps, or some types of LED lamps, but when the phase cut dimmer is compatible with a smart LED lamp, additional circuit design may be required to ensure compatibility and dimming stability. The bleeder module 102 plays a very critical role in a dimming control circuit, and the bleeder module 102 mainly functions to protect the circuit and ensure normal operation of the circuit. In particular, in the compatible design of the smart lamp and the phase cut dimmer, when a control signal of the dimmer changes, the bleeder module 102 can help a lamp to quickly adapt to a new working condition, thereby avoiding flickering or unstable brightness. In the phase cut dimming process, the bleeder module 102 can help eliminate current fluctuation caused by phase cut angle change, and ensure that the smart lamp can work stably under different brightness settings, avoiding flickering or uneven brightness, and improving the user experience. In the combined design of the smart lamp and the phase cut dimmer, the bleeder module 102 not only protects sensitive electronic components in the smart lamp, but also ensures the stability and compatibility of the lamp under the control of phase cut dimming, thereby improving the performance of the entire system and the user experience. The bleeder module 102 may comprise the following components: 1) a resistor: used for discharging charges in a capacitor or serving as a part of a current bleeder path; 2) a TVS diode or a Zener diode: which achieves fast response to voltage spikes, and protects the circuit from overvoltage damage; and 3) a capacitor: which provides a transient current when a power supply is cut off, helping a driver IC to start up steadily. By the proper design and configuration of these components, the bleeder module 102 can ensure that under control of the phase cut dimmer, the smart lamp can operate stably and safely even under severe conditions of small-angle phase cut, providing continuous and smooth brightness adjustment, without affecting the lifetime or performance of the lamp; and by generating a current signal on the basis of the operating state of the lamp, and transmitting the current signal to the phase cut dimmer, it can be ensured that the phase cut dimmer can continuously operate. For example, in cases where the operating current of the lamp is extremely small, the bleeder module 102 may generate a holding current, and supply the holding current to the phase cut dimmer, so as to maintain normal operation of the phase cut dimmer.

The phase cut angle measurement module 104 is configured to measure the phase cut angle of the phase cut dimmer. On the basis of the phase cut angle of the phase cut dimmer, a maximum allowable current of the lamp can be determined.

The logic module 106 is configured to receive the phase cut angle measured by the phase cut angle measurement module 104 and generate a phase cut angle signal on the basis of the phase cut angle.

The control module 108 is configured to receive the phase cut angle signal of the logic module 104, the control module 108 generates a dimming signal on the basis of the phase cut angle signal and transmits the dimming signal to the logic module 106, and then the logic module 106 generates a control signal on the basis of the dimming signal. For example, the control module 108 may be implemented in the form of an MCU.

The dimming module 110 is configured to receive the control signal of the logic module 106, and perform dimming control on the lamp on the basis of the control signal. The lamp adjusts a parameter of the lamp according to the control signal; wherein the parameter may at least include the brightness of light emitted by the lamp. For example, the dimming module 110 may be implemented in the form of a current source. In this way, dimming control can be performed on the lamp in two dimming modes, i.e. wireless control and phase cut dimming, thereby enhancing the control flexibility of the smart lamp and the universality of application scenarios.

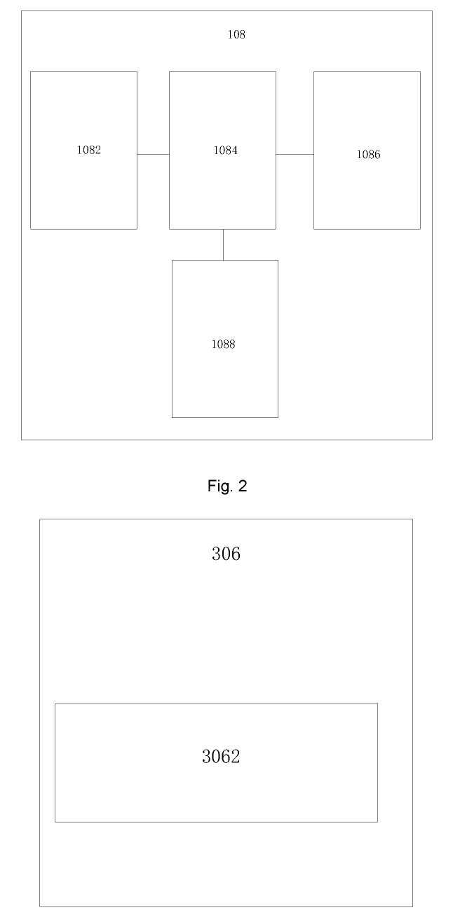

FIG. 2 is a schematic diagram of a control module according to embodiments of the present application. As shown in FIG. 2, the control module 108 comprises: a limit unit 1082, an adjustment unit 1084, and a dimming signal generation unit 1086.

The limit unit 1082 is configured to generate a limit signal on the basis of the phase cut angle signal, the limit signal defining the maximum current of the lamp. For example, a user changes the phase cut angle of the phase cut dimmer by means of at least one of a wall switch, a remote control unit and a voice control recognition unit, such that in each alternating-current cycle, the phase cut dimmer delays a conduction time point of the sinusoidal waveform, so that a part of a front half part or a rear half part of the waveform is cut off, thereby reducing effective values of a voltage and a current which are actually supplied to the lamp, limiting the maximum current of the lamp, and further realizing brightness adjustment. The limit unit 1082 determines the maximum current of the lamp on the basis of the phase cut angle signal, thereby generating a limit signal.

The adjustment unit 1084 is configured to generate an adjustment signal on the basis of pre-stored data or an external control signal, the adjustment signal defining an adjustment range of the dimming signal. For example, the pre-stored data may be correlation data pre-stored in a memory of the control module 108, wherein the correlation data may define an adjustment range of power at a certain maximum current. For example, the adjustment range of power can range from 1% to 100%, and thus the actual current of the lamp can be adjusted to 10% of the maximum current by the adjustment signal. In addition, for example, the external control signal may be provided by a user or associated operator by externally setting designated correlation data, wherein the correlation data may define an adjustment range of power at a certain maximum current. For example, the adjustment range of power can range from 1% to 100%, and thus the actual current of the lamp can be adjusted to 10% of the maximum current by the adjustment signal.

The dimming signal generation unit 1086 is configured to generate the dimming signal on the basis of the limit signal and the adjustment signal. The dimming signal enables the actual current of the lamp to be adjusted within a range specified by the adjustment signal, and ensures that the actual current of the lamp is less than or equal to the maximum current.

In addition, the control module 108 may further comprise a communication unit 1088, wherein the communication unit 1088 is configured to receive the external control signal sent by a user in a wired or wireless manner. The adjustment unit 1084 may generate the adjustment signal on the basis of the external control signal. For example, the user may specify a dimming range and a dimming rule by an application program installed on a smart terminal, and generate the external control signal on the basis of the dimming range and the dimming rule. Therefore, the user can specify the dimming range and the dimming rule according to actual requirements.

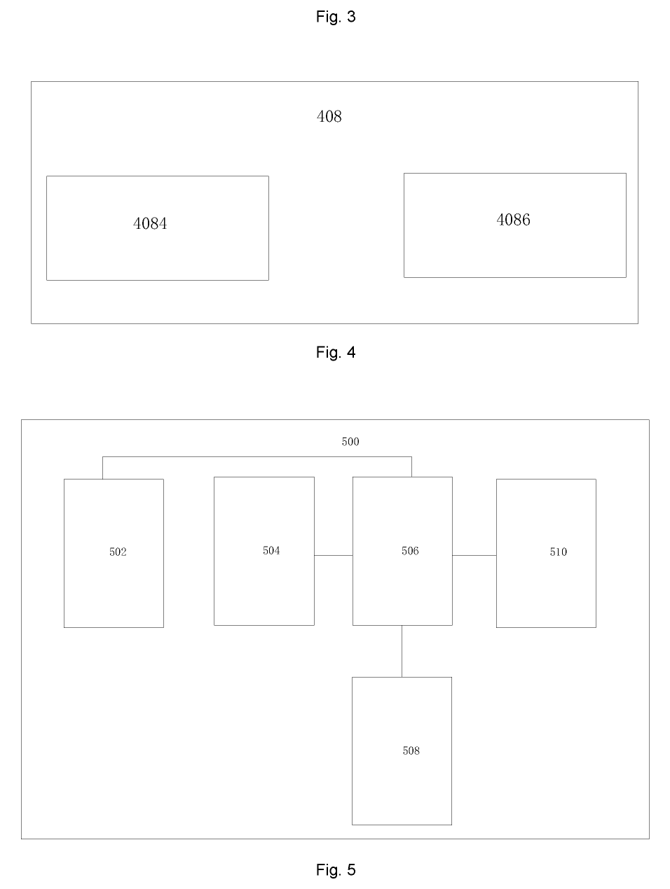

FIG. 3 is a schematic diagram of a logic module according to another embodiment of the present application. As shown in FIG. 3, the logic module 306 comprises a limit unit 3062. The limit unit 3062 is configured to generate a limit signal on the basis of the phase cut angle signal, the limit signal defining the maximum current of the lamp. For example, a user changes the phase cut angle of the phase cut dimmer by means of at least one of a wall switch, a remote control unit and a voice control recognition unit, such that in each alternating-current cycle, the phase cut dimmer delays a conduction time point of the sinusoidal waveform, so that a part of a front half part or a rear half part of the waveform is cut off, thereby reducing effective values of a voltage and a current which are actually supplied to the lamp, limiting the maximum current of the lamp, and further realizing brightness adjustment. The limit unit 3062 determines the maximum current of the lamp on the basis of the phase cut angle signal, thereby generating a limit signal.

FIG. 4 is a schematic diagram of a control module according to another embodiment of the present application. The control module 408 shown in FIG. 4 may be used in conjunction with the logic module 306 shown in FIG. 3. The control module 408 shown in FIG. 4 comprises an adjustment unit 4084 and a dimming signal generation unit 4086. The adjustment unit 4084 is configured to generate an adjustment signal, the adjustment signal defining an adjustment range of the dimming signal. For example, the actual current of the lamp can be adjusted to 10% of the maximum current by the adjustment signal. The dimming signal generation unit 4086 is configured to generate the dimming signal on the basis of the adjustment signal. The dimming signal enables the actual current of the lamp to be adjusted within a range specified by the adjustment signal. In addition, although not shown, the control module 408 may also comprise a communication unit, which is configured to receive the external control signal sent by a user in a wired or wireless manner. The adjustment unit 4084 may generate the adjustment signal on the basis of the external control signal. For example, the user may specify a dimming range and a dimming rule by an application program installed on a smart terminal, and generate the external control signal on the basis of the dimming range and the dimming rule. Therefore, the user can specify the dimming range and the dimming rule according to actual requirements. The control module 408 shown in FIG. 4 may transmit the adjustment signal to the logic module 306 shown in FIG. 3.

The logic module 306 shown in FIG. 3 generates the control signal on the basis of the limit signal generated by the limit unit 3062 and the dimming signal generated by the dimming signal generation unit 4086. On the basis of the control signal, the actual current of the lamp can be adjusted within a range specified by the adjustment signal, and it is ensured that the actual current of the lamp is less than or equal to the maximum current.

FIG. 5 is a schematic diagram of an apparatus for controlling a lamp according to another embodiment of the present application. As shown in FIG. 5, the apparatus 500 for controlling a lamp has a structure similar to that of the apparatus 100 shown in FIG. 1, and comprises: a bleeder module 502, a phase cut angle measurement module 504, a logic module 506, a control module 508 and a dimming module 510. As actually needed, the bleeder module 502, the phase cut angle measurement module 504, the logic module 506, the control module 508, and the dimming module 510 may employ structures and configurations similar to those as shown in FIGS. 1 to 4. In addition, in the apparatus 500 for controlling a lamp according to another embodiment of the present application, a control relationship exists between the logic module 506 and the bleeder module 502. That is, the logic module 506 detects the operating state of the lamp (not shown), and controls a working state of the bleeder module 502 on the basis of the operating state of the lamp. For example, the logic module 506 detects the operating state of the lamp; and when the operating state of the lamp indicates that a working current of the lamp is greater than a predetermined threshold, the phase cut dimmer will not enter a state in which it cannot work normally due to an extremely small working current of the lamp, and therefore, for the purpose of reducing power consumption, the working state of the bleeder module 502 may be controlled to be switched to a standby state; and in the standby state, the bleeder module 502 does not transmit a current signal to the phase cut dimmer. In addition, when the operating state of the lamp indicates that a working current of the lamp is smaller than the predetermined threshold, the phase cut dimmer may enter a state in which it cannot work normally due to an extremely small working current of the lamp, therefore, in order to keep the phase cut dimmer to work normally, the working state of the bleeder module 502 may be controlled to be switched to a normal working state; in the normal operating state, the bleeder module 502 transmits a holding current signal to the phase cut dimmer, so that the phase cut dimmer can use the holding current signal to maintain a normal working state. By the described manner, by controlling the bleeder module 502 to switch between a normal operation mode and a low power consumption mode, further low power consumption of an illumination device and a control apparatus therefor is ensured while achieving the dimming function of the lamp.

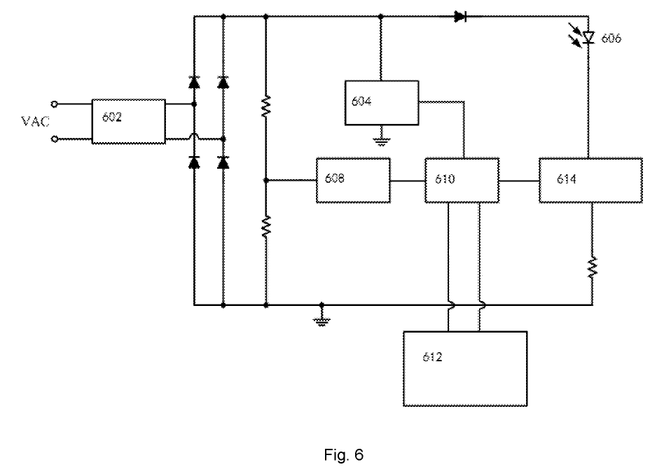

FIG. 6 is a schematic diagram of a circuit of an apparatus for controlling a lamp according to another embodiment of the present application. As shown in FIG. 6, an input end of a phase cut dimmer 602 is connected to an external alternating-current power supply VAC. A bleeder module 604 is configured to generate a current signal on the basis of an operating state of the lamp 606 and transmit the current signal to a phase cut dimmer 602. A phase cut angle measurement module 608 is configured to measure the phase cut angle of the phase cut dimmer 602. A logic module 610 is configured to receive the phase cut angle measured by the phase cut angle measurement module 608 and generate a phase cut angle signal on the basis of the phase cut angle. A control module 612 is configured to receive the phase cut angle signal of the logic module 610, generate a dimming signal on the basis of the phase cut angle signal and transmit the dimming signal to the logic module 610, and then the logic module 610 generates a control signal on the basis of the dimming signal. For example, the control module 612 may be implemented in the form of an MCU. A dimming module 614 is configured to receive the control signal of the logic module 610, and perform dimming control on the lamp 606 on the basis of the control signal. The lamp adjusts a parameter of the lamp according to the control signal; wherein the parameter may at least comprise the brightness of light emitted by the lamp. In this way, dimming control can be performed on the lamp in two dimming modes, i.e. wireless control and phase cut dimming, thereby enhancing the control flexibility of the smart lamp and the universality of application scenarios. Although the logic module 610 and the control module 612 are shown as two independent units in FIG. 6, the logic module 610 and the control module 612 may be integrated into one unit as actually needed. Additionally, as shown in FIG. 6, a control relationship exists between the logic module 610 and the bleeder module 604. That is, the logic module 610 detects the operating state of the lamp 606, and controls a working state of the bleeder module 604 on the basis of the operating state of the lamp 606. For example, the logic module 610 detects the operating state of the lamp 606; and when the operating state of the lamp 606 indicates that a working current of the lamp is greater than a predetermined threshold, the phase cut dimmer 602 will not enter a state in which it cannot work normally due to an extremely small working current of the lamp 606, and therefore, for the purpose of reducing power consumption, the logic module 610 may control the working state of the bleeder module 604 to be switched to a standby state; and in the standby state, the bleeder module 604 does not transmit a current signal to the phase cut dimmer 602. In addition, when the operating state of the lamp 606 indicates that a working current of the lamp 606 is smaller than the predetermined threshold, the phase cut dimmer 602 may enter a state in which it cannot work normally due to an extremely small working current of the lamp 606; therefore, in order to keep the phase cut dimmer 602 to work normally, the logic module 610 may control the working state of the bleeder module 604 to be switched to a normal working state; in the normal operating state, the bleeder module 604 transmits a holding current signal to the phase cut dimmer, so that the phase cut dimmer 602 can use the holding current signal to maintain a normal working state. By the described manner, by controlling the bleeder module 604 to switch between a normal operation mode and a low power consumption mode, further low power consumption of an illumination device and a control apparatus therefor is ensured while achieving the dimming function of the lamp 606.

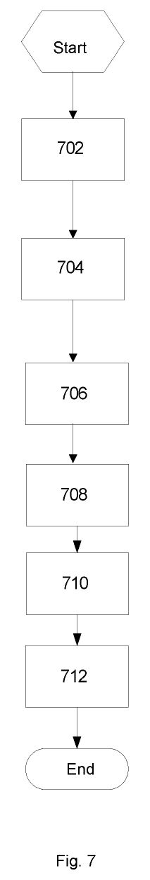

FIG. 7 is a flowchart of a method for controlling a lamp according to an embodiment of the present application. As shown in FIG. 7, the method for controlling a lamp comprises the following steps: a bleeding step 702 of generating a current signal on the basis of an operating state of the lamp and transmitting the current signal to a phase cut dimmer; wherein the phase cut dimmer receives an external alternating-current signal, and controls the on or off of the external alternating-current signal by changing a phase cut angle; a phase cut angle measuring step 704 of measuring the phase cut angle of the phase cut dimmer; a phase cut angle signal generating step 706 of receiving the phase cut angle measured by the phase cut angle measurement module and generating a phase cut angle signal representing the phase cut angle; a dimming signal generating step 708 of receiving the phase cut angle signal generated in the phase cut angle signal generating step and generating a dimming signal on the basis of the phase cut angle signal; and a control signal generating step 710 of receiving the dimming signal and generating a control signal on the basis of the dimming signal; and a lamp controlling step 712 of receiving the control signal generated in the control signal generating step and performing dimming control on the lamp on the basis of the control signal.

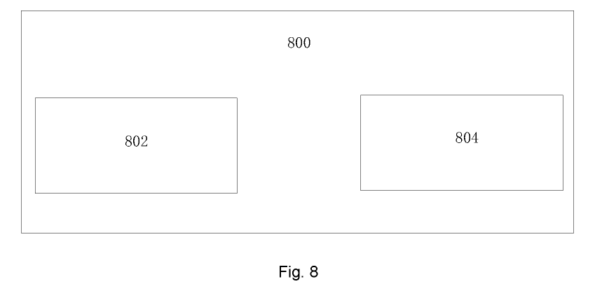

FIG. 8 is a schematic diagram of a smart lamp according to an embodiment of the present application. As shown in FIG. 8, the smart lamp 800 comprises: a light source 802, which can generate light having two or more brightness; and an apparatus 804 for controlling the light source, the apparatus 804 may comprise: a bleeder module, configured to generate a current signal on the basis of an operating state of the lamp and transmit the current signal to a phase cut dimmer; wherein the phase cut dimmer receives an external alternating-current signal, and controls the on or off of the external alternating-current signal by changing a phase cut angle; a phase cut angle measurement module, configured to measure the phase cut angle of the phase cut dimmer; a logic module, configured to receive the phase cut angle measured by the phase cut angle measurement module and generate a phase cut angle signal representing the phase cut angle; a control module, configured to receive the phase cut angle signal of the logic module, generate a dimming signal on the basis of the phase cut angle signal, and transmit the dimming signal to the logic module, the logic module generating a control signal on the basis of the dimming signal; and a dimming module, configured to receive the control signal of the logic module and perform dimming control on the lamp on the basis of the control signal. As actually needed, the bleeder module, the phase cut angle measurement module, the logic module, the control module, and the dimming module may employ structures and configurations similar to those as shown in FIGS. 1 to 6.

The solution solves the following technical problems: a smart lamp cannot perform dimming after a phase cut dimmer, that is, the smart lamp generally can only work under a large phase cut angle, but cannot perform normal dimming under the control of a small-angle or phase cut dimmer, limiting the usage scenario of the smart lamp and limiting the user experience. In this way, users can use the smart lamp without changing an existing phase cut dimmer, thereby improving the user friendliness and market acceptance of the smart lamp. In addition, the smart lamp supports two dimming modes, i.e. wireless control and phase cut dimming, thereby enhancing the control flexibility of the smart lamp and the universality of application scenarios.

In the described embodiments of the present application, the illustration of each embodiment has its own emphasis. For the part not detailed in a certain embodiment, please refer to the relevant illustration in other embodiments.

In the several embodiments provided in the present application, it should be understood that the disclosed technical content may be implemented in other manners. The apparatus embodiments described above are merely illustrative. For example, the division of a unit or a module is only a logical function division, and in actual implementation, there may be another division manner, for example, multiple units or modules or assemblies may be combined, or can be integrated into another system, or some features can be ignored or not executed. In addition, the coupling or direct coupling or communication connection shown or discussed may be an indirect coupling or communication connection via some interfaces, modules or units, and may be electrical or other forms.

The units or modules described as separate components may or may not be physically separated, and the components displayed as units or modules may or may not be physical units or modules, that is, may be located in one place, or may be distributed in a plurality of network units or modules. Some or all of the units or modules may be selected according to actual needs to achieve the purpose of the solutions of the embodiments.

In addition, functional units or modules in the embodiments of the present application may be integrated into one processing unit or module, or the units or modules may exist alone physically, or two or more units or modules are integrated into one unit or module. The described integrated unit or module can be embodied in the form of hardware or in the form of a software functional unit or module.

If the integrated unit is implemented in the form of a software functional unit and is sold or used as an independent product, the integrated unit can be stored in a computer-readable storage medium. On the basis of such understanding, the part of the technical solution of the present application that contributes in essence or to the prior art or all or part of the technical solution may be embodied in the form of a software product stored in a storage medium. Several instructions are included in the storage medium to enable a computer device (which may be a personal computer, server or network device, etc.) to execute all or some of the steps of the methods of various embodiments of the present application. Moreover, the storage medium above comprises: media such as a USB flash disk, a Read-Only Memory (ROM), a Random Access Memory (RAM), a removable hard disk, a magnetic disk, or an optical disk which can store program codes.

The illustration above only relates to preferred embodiments of the present application. It should be noted that for a person of ordinary skill in the present technical field, several improvements and modifications can also be made without departing from the principle of the present application, and these improvements and modifications shall also be considered as within the scope of protection of the present application.

1. An apparatus having a lamp controlled by a wireless controller, the apparatus comprising:
a bleeder module, configured to generate a current signal on the basis of an operating state of the lamp and transmit the current signal to a phase cut dimmer; wherein the phase cut dimmer receives an external alternating-current signal, and controls, by changing a phase cut angle, the on or off of the external alternating-current signal to be supplied to the lamp;
a phase cut angle measurement module, configured to measure the phase cut angle of the phase cut dimmer;
a logic module, configured to receive the phase cut angle measured by the phase cut angle measurement module and generate a phase cut angle signal on the basis of the phase cut angle;
a control module, configured to receive the phase cut angle signal of the logic module, generate a dimming signal on the basis of the phase cut angle signal, and transmit the dimming signal to the logic module, the logic module generating a control signal on the basis of the dimming signal; and
a dimming module, configured to receive the control signal of the logic module and perform dimming control on the lamp on the basis of the control signal.

2. The apparatus having a lamp controlled by a wireless controller according to claim 1, wherein the control module comprises:
a limit unit, configured to generate a limit signal on the basis of the phase cut angle signal, the limit signal defining the maximum current of the lamp;
an adjustment unit, configured to generate an adjustment signal on the basis of pre-stored data or an external control signal, the adjustment signal defining an adjustment range of the dimming signal; and
a dimming signal generation unit, configured to generate the dimming signal on the basis of the limit signal and the adjustment signal.

3. The apparatus having a lamp controlled by a wireless controller according to claim 2, wherein the control module further comprises:
a communication unit, configured to receive the external control signal.

4. The apparatus having a lamp controlled by a wireless controller according to claim 3, wherein the communication unit receives the external control signal sent by a user in a wired or wireless manner.

5. The apparatus having a lamp controlled by a wireless controller according to claim 1, wherein the logic module detects the operating state of the lamp, and controls a working state of the bleeder module on the basis of the operating state of the lamp.

6. The apparatus having a lamp controlled by a wireless controller according to claim 5, wherein the logic module detects the operating state of the lamp; and when the operating state of the lamp indicates that a working current of the lamp is greater than a predetermined threshold, the working state of the bleeder module is controlled to be switched to a standby state, wherein in the standby state, the bleeder module does not transmit the current signal to the phase cut dimmer; and when the operating state of the lamp indicates that the working current of the lamp is smaller than the predetermined threshold, the working state of the bleeder module is controlled to be switched to a normal operating state, wherein in the normal operating state, the bleeder module transmits the current signal to the phase cut dimmer.

7. The apparatus having a lamp controlled by a wireless controller according to claim 1, wherein the logic module comprises: a limit unit, configured to generate a limit signal on the basis of the phase cut angle signal, the limit signal defining the maximum current of the lamp.

8. The apparatus having a lamp controlled by a wireless controller according to claim 7, wherein the control module comprises:
an adjustment unit, configured to generate an adjustment signal on the basis of pre-stored data or an external control signal, the adjustment signal defining an adjustment range of the dimming signal; and
a dimming signal generation unit, configured to generate the dimming signal on the basis of the adjustment signal.

9. The apparatus having a lamp controlled by a wireless controller according to claim 8, wherein the logic module generates the control signal on the basis of the dimming signal and the limit signal.

10. A smart lamp controlled by a wireless controller, comprising:
a light source, the light source being capable of generating light having two or more brightness; and
an apparatus for controlling the light source, the apparatus comprising:
a bleeder module, configured to generate a current signal on the basis of an operating state of the lamp and transmit the current signal to a phase cut dimmer; wherein the phase cut dimmer receives an external alternating-current signal, and controls, by changing a phase cut angle, the on or off of the external alternating-current signal to be supplied to the light source;
a phase cut angle measurement module, configured to measure the phase cut angle of the phase cut dimmer;
a logic module, configured to receive the phase cut angle measured by the phase cut angle measurement module and generate a phase cut angle signal representing the phase cut angle;
a control module, configured to receive the phase cut angle signal of the logic module, generate a dimming signal on the basis of the phase cut angle signal, and transmit the dimming signal to the logic module, the logic module generating a control signal on the basis of the dimming signal; and
a dimming module, configured to receive the control signal of the logic module and perform dimming control on the light source on the basis of the control signal.

11. The smart lamp controlled by a wireless controller according to claim 10, wherein the control module comprises:
a limit unit, configured to generate a limit signal on the basis of the phase cut angle signal, the limit signal defining the maximum current of the lamp;
an adjustment unit, configured to generate an adjustment signal on the basis of pre-stored data or an external control signal, the adjustment signal defining an adjustment range of the dimming signal; and
a dimming signal generation unit, configured to generate the dimming signal on the basis of the limit signal and the adjustment signal.

12. The smart lamp controlled by a wireless controller according to claim 11, wherein the control module further comprises:
a communication unit, configured to receive the external control signal.

13. The smart lamp controlled by a wireless controller according to claim 12, wherein the communication unit receives the external control signal sent by a user in a wired or wireless manner.

14. The smart lamp controlled by a wireless controller according to claim 10, wherein the logic module detects the operating state of the lamp, and controls a working state of the bleeder module on the basis of the operating state of the light source.

15. The smart lamp controlled by a wireless controller according to claim 14, wherein the logic module detects the operating state of the light source; and when the operating state of the light source indicates that a working current of the light source is greater than a predetermined threshold, the working state of the bleeder module is controlled to be switched to a standby state, wherein in the standby state, the bleeder module does not transmit the current signal to the phase cut dimmer; and when the operating state of the light source indicates that the working current of the light source is smaller than the predetermined threshold, the working state of the bleeder module is controlled to be switched to a normal operating state, wherein in the normal operating state, the bleeder module transmits the current signal to the phase cut dimmer.

16. The smart lamp controlled by a wireless controller according to claim 10, wherein the logic module comprises: a limit unit, configured to generate a limit signal on the basis of the phase cut angle signal, the limit signal defining the maximum current of the light source.

17. The smart lamp controlled by a wireless controller according to claim 16, wherein the control module comprises:
an adjustment unit, configured to generate an adjustment signal on the basis of pre-stored data or an external control signal, the adjustment signal defining an adjustment range of the dimming signal; and
a dimming signal generation unit, configured to generate the dimming signal on the basis of the adjustment signal.

18. The smart lamp controlled by a wireless controller according to claim 17, wherein the logic module generates the control signal on the basis of the dimming signal and the limit signal.

19. A method for controlling a lamp, the method comprising:
a bleeding step of generating a current signal on the basis of an operating state of the lamp and transmitting the current signal to a phase cut dimmer; wherein the phase cut dimmer receives an external alternating-current signal, and controls, by changing a phase cut angle, the on or off of the external alternating-current signal to be supplied to the lamp;
a phase cut angle measuring step of measuring the phase cut angle of the phase cut dimmer;
a phase cut angle signal generating step of receiving the phase cut angle measured in the phase cut angle measurement step and generating a phase cut angle signal representing the phase cut angle;
a dimming signal generating step of receiving the phase cut angle signal generated in the phase cut angle signal generating step and generating a dimming signal on the basis of the phase cut angle signal;
a control signal generating step of receiving the dimming signal generated in the dimming signal generating step and generating a control signal on the basis of the dimming signal; and
a lamp controlling step of receiving the control signal generated in the control signal generating step and performing dimming control on the lamp on the basis of the control signal.

20. The method for controlling a lamp according to claim 19, wherein the dimming signal generating step comprises the following sub-steps:
a first sub-step of generating a limit signal on the basis of the phase cut angle signal, the limit signal defining the maximum current of the lamp;
a second sub-step of generating an adjustment signal on the basis of pre-stored data or an external control signal, the adjustment signal defining an adjustment range of the dimming signal; and
a third sub-step of generating the dimming signal on the basis of the limit signal and the adjustment signal.
